(19) United States
(12) Patent Application Publication
(10) Pub. No.: US 2023/0047989 A1
(43) Pub. Date: Feb. 16, 2023

(54) COATED POLYURETHANE FOAMS

(71) Applicants: Dow Global Technologies LLC, Midland, MI (US); Rohm and Haas Company, Collegeville, PA (US)

(72) Inventors: Yasmin N. Srivastava, Sugarland, TX (US); Xindi Yu, Paoli, PA (US); Irfan Khan, Houston, TX (US); Rogelio Gamboa, Brazoria, TX (US); Saul Garcia, Lake Jackson, TX (US)

(21) Appl. No.: 17/789,912

(22) PCT Filed: Jan. 27, 2021
(86) PCT No.: PCT/US2021/015193

§ 371 Date: Jun. 29, 2022

Related U.S. Application Data
(60) Provisional application No. 62/968,193, filed on Jan. 31, 2020.

(51) Int. Cl. C08J 9/36; C08J 9/00; C08K 3/38; C08K 9/10; C09D 133/08; C09D 7/61; C09D 7/63; C09D 7/40

(52) U.S. Cl. CPC C08J 9/365; C08J 9/0009; C08J 9/0066; C08K 3/38; C08K 9/10; C09D 133/08; C09D 7/61; C09D 7/63; C09D 7/69; C08K 2003/385; C08K 2201/005; C08J 2375/04; C08J 2205/06

(57) ABSTRACT

Articles useful for bedding and other comfort applications include a coated polyurethane foam. The coating includes an elastomeric polymer, a phase change material and ceramic particles. The coating provides desirable haptic properties, including a cool touch feature that creates a sensation of coolness when touched. The invention is also a coating composition for producing such a coating, and a method for producing the coating composition

This invention relates to flexible polyurethane foams that are useful in cushioning applications, in particular so-called “comfort applications” such as bedding and pillows.

Polyurethane foams are used in very large quantities to make cushioning materials, in particular for bedding and seating. A growing segment of these polyurethane foams are the low resiliency, slow-recovering type, which are sometimes known as “viscoelastic” or “memory” foams. A problem with these foams is that they do not conduct heat very effectively. Heat given off by a user is trapped by the foam in the regions closely adjacent to the user's body, which results in a localized temperature rise that is perceived by the user as being uncomfortable.

To combat this problem, so-called “gel technology” is used to impart a sense of coolness to the touch, which is important at point-of-sale. “Gel technology” involves using a phase change material to impart a “cool touch” feature to the foam. The phase change material (or “gels”) has a melting or phase transition temperature at about room temperature or slightly higher. They effectively absorb body heat when touched, as the body heat causes the material to undergo its phase change. This causes the sensation of coolness when first touched.

The phase change material can be used as a surface topper or can be infused within the foams. When used as a surface topper, the phase change material provides “cool touch” but eventually begins to trap body heat due to the impermeability of the gel material. Large quantities of the phase change material are needed. Because the phase change material is encapsulated in a hard shell, it can cause the surface topper to become stiff and brittle.

WO 2017/210439 describes a polyurethane foam having a surface coating that contains an encapsulated phase change material. The coating is prepared from an aqueous emulsion that is applied to the foam and dried. This approach offers many advantages. It provides the desired “cool touch” feature in a coating layer that is thin, flexible and soft. Nonetheless, further improvements are desirable. Further improvement in cooling is desirable. The coatings sometimes also tend to be somewhat sticky when the phase change material is warm.

This invention is an article comprising a flexible polyurethane foam and a cured coating of a solid, water-insoluble elastomeric polymer adhered to at least one surface of the flexible polyurethane foam, the cured coating having embedded therein (i) particles of an encapsulated phase change material, the phase change material having a melting or glass transition temperature of 25 to 37° C. and (ii) ceramic particles having a particle size of up to 50 μm, the encapsulated phase change material constituting 10 to 70 weight percent of the combined weight of the elastomeric polymer, encapsulated phase change material particles and ceramic particles, and the ceramic particles constituting 2 to 25 weight percent of the combined weight of the elastomeric polymer, encapsulated phase change material particles and ceramic particles.

The coating exhibits beneficial haptic properties that render the article particularly useful for bedding and other comfort applications. These include low microtexture roughness and microtexture coarseness; low adhesive tack; and good thermal cooling and thermal persistence properties that produce a desirable “cool touch” attribute. Comfort applications include those in which during use the foam becomes exposed to the body heat of or water vapor evaporating from the body of a human user. The foam or an article containing the foam in such applications often supports at least a portion of the weight of a human user and becomes compressed during use. Examples of such comfort applications include pillows; mattress toppers, mattresses, comforters, furniture and/or automotive seating; quilting; insulated clothing and the like.

The invention in another aspect is a coating composition useful for producing the foregoing article. The coating composition comprises a liquid phase containing water and/or one or more other compounds that are liquid at 23° C. and have a boiling temperature at standard pressure of 40 to 100° C., a water-insoluble elastomeric polymer dispersed in the liquid phase in the form of particles or droplets, particles of an encapsulated phase change material dispersed in the liquid phase and ceramic particles dispersed in the liquid phase, wherein the phase change material constitutes 40 to 60 percent of the total weight of the elastomeric polymer, encapsulated phase change material particles and ceramic particles and the ceramic particles constitute 8 to 20 percent of the total weight of the elastomeric polymer, encapsulated phase change material particles and ceramic particles.

The invention is also a method for preparing such a coating composition, comprising:

A. charging all or a portion of the liquid phase into the interior of a mixing vessel equipped with an agitation system that includes a motor, shaft, disperser impeller and at least one pumping impeller, the disperser impeller and pumping impeller being mounted on the shaft with the pumping impeller being positioned above the disperser impeller;

B. rotating a disperser impeller to agitate the liquid phase in the mixing vessel to create a vortex at a surface of the liquid phase in the mixing vessel, while maintaining the pumping impeller above the surface of the liquid phase in the mixing vessel;

C. adding the ceramic particles to the liquid phase while continuing to rotate the disperser impeller while maintaining the surface of the liquid phase in the mixing vessel below the pumping impeller;

D. then positioning the pumping impeller below the surface of the liquid phase in the mixing vessel and adding the elastomeric polymer and optionally additional liquid phase to the liquid phase in the mixing vessel while agitating the liquid phase with both the disperser impeller and the pumping impeller to maintain a vortex at the surface of the liquid phase;

E. simultaneously with or after step D, adding the encapsulated phase change material to the liquid phase in the mixing vessel while continuing agitation with both the disperser impeller and the pumping impeller to maintain a vortex at the surface of the liquid phase.

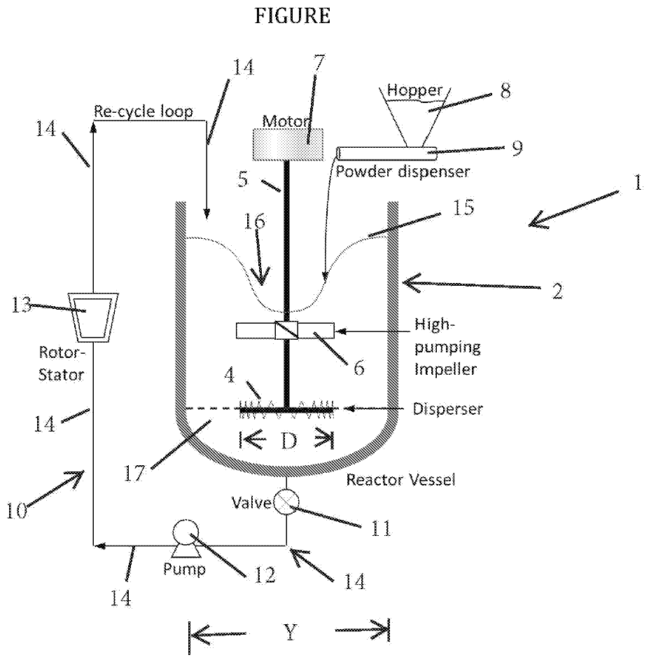

FIG. 1 is a schematic view of an apparatus for preparing a coating composition useful in the invention.

The flexible polyurethane foam (without the coating) may have, for example, a foam density of at least 24 kg/m³, at least 32 kg/m³, at least 36 kg/m³ or at least 40 kg/m³, as measured according to ASTM D-3574. The foam density may be, for example, up to 120 kg/m³, up to 104 kg/m³, up to 92 kg/m³ or up to 80 kg/m³. The flexible polyurethane foam may exhibit an elongation to break of at least 50%, at least 75% or at least 100%.

The flexible polyurethane foam (without the coating) may exhibit a compression force deflection (CFD) value of 0.4 to 15.0 kPa, and more preferably 0.4 to 10 kPa, 0.4 to 5 kPa, 0.4 to 2.5 kPa or 0.4 to 1.5 kPa, at 40% compression, as measured according to ISO3386−1.

The flexible polyurethane foam (without the coating) may exhibit a resiliency of up to 70%, up to 60%, up to 50%, up to 25%, up to 20%, up to 15% or up to 10% on the ball rebound test of ASTM D-3574.

The flexible polyurethane foam (without the coating) may exhibit a recovery time of at least one second or at least 2 seconds and up to 15 seconds, preferably up to 10 seconds. Recovery time for purposes of this invention is measured by compressing a 2.0-inch (5.08 cm) thick foam piece (4.0×4.0×2.0 inches, 10.16×10.16×5.08 cm) to 24% of its original thickness at room temperature, holding the foam at that compression for one minute and releasing the compressive force. The time required after the compressive force is released for the foam to regain 90% of original foam thickness is the recovery time. Recovery time is conveniently measured using a viscoelastic foam-testing device such as a RESIMAT 150 device (with factory software) from Format Messtechnik GmbH.

The flexible polyurethane foam may exhibit an airflow of at least 0.8 L/s as measured according to ASTM D3574 test G. The airflow may be at least 1.2 L/s or at least 1.4 L/s and may be, for example, up to 8 L/s, up to 6 L/s or up to 4 L/s.

In a preferred embodiment, the flexible polyurethane foam is characterized in having a foam density of 32 to 92 kg/m³, a resiliency of at most 20% or at most 10%, and a recovery time of at least one second or at least two seconds and up to 10 seconds.

The foam in some embodiments exhibits a moisture wicking time of 5 seconds or less, preferably 4 seconds or less. Moisture wicking time is measured on 5.08×5.08×2.54 cm skinless samples that are dried to constant weight. 3 mL of room temperature water is slowly dropped onto the top surface of the foam sample from a pipette so as t avoid splashing, and the amount of time required for the foam to absorb the water is recorded as the wicking time.

Polyurethane foams having the foregoing characteristics can be prepared using general methods such as are described in, for example, in WO 2017/210439, U.S. Pat. Nos. 4,365,025, 6,479,433, 8,809,410, 9,814,187 and 9,840,575, US Published Patent Application Nos. 2004−0049980, 2006−0142529 and 2016−0115387, and PCT/US2018/052323, among many others.

The polyurethane foam may be in the form of an article having a volume (when uncompressed) of at least 200 cm³. Such an article may have a volume, for example of at least 1 liter, at least 3 liters, or at least 5 liters. The volume may be, for example, up to 10,000 liters or up to 1000 liters. The polyurethane foam article may be, for example, a pillow, a mattress or a mattress topper. The article may be molded, i.e., prepared in a mold in which the internal geometry is the same as the external geometry of the article. The article may be a cut foam made by fabricating a larger foam body to the final dimensions and geometry of the article.

The cured coating includes an elastomeric polymer which is a room temperature (23° C.) solid and insoluble in water. The elastomeric polymer by itself (i.e., in the absence of the phase change material and ceramic particles) preferably has a glass transition temperature of no greater than 0° C. (as measured by differential scanning calorimetry and an elongation to break of at least 50%. An elastomeric polymer having those characteristics is considered for purposes of this invention to be elastomeric. The elastomeric polymer by itself may have a glass transition temperature of no greater than −15° C., no greater than −25° C. or no greater than −40° C. Its elongation to break may be 100% or more.

Examples of suitable elastomeric polymers include natural rubber and synthetic polymers such as homopolymers and copolymers of conjugated dienes such as butadiene and isoprene; homopolymers and copolymers of acrylate monomers such as methyl acrylate, ethyl acrylate, hydroxyethylacryate, butyl acrylate and the like; homopolymers and copolymers of isobutylene; nitrile rubbers; polysulfide rubbers, silicone rubbers; homopolymers and copolymers of neoprene; polyurethane rubber and the like.

Embedded in the cured coating are (i) particles of an encapsulated phase change material and (ii) ceramic particles having a particle size of up to 50 μm.

The encapsulated phase change material includes a phase change material that has a melting or glass transition temperature of 25 to 37° C., which phase change material is contained within a shell. The weight of the phase change material, for purposes of this invention, includes the weight of the shell. The shell may constitute, for example, 5 to 25% of the total weight of the encapsulated phase change material, the phase change material itself constituting the remainder thereof, i.e., 75 to 95% by weight thereof.

The phase change material may be or contain, for example, any one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax. The phase change material in some embodiments is an alkane having 14 to 30, especially 14 to 24 or 16 to 22 carbon atoms or a mixture of any two or more of such alkanes. In a specific embodiment, the phase change material includes octadecane and/or eicosane. The phase change material preferably has a melting temperature of 25 to 37° C., especially 25 to 32° C. or 28 to 32° C.

The encapsulated phase change material may exhibit a heat of fusion within the temperature range of 25 to 37° C. of at least 50 Joule/gram (J/g), at least 100 J/g or at least 150 J/g, as measured by differential scanning calorimetry. The heat of fusion may be as much as 300 J/g or more, but is more commonly up to 250 J/g or up to 200 J/g.

The shell material may be, for example, a polymeric material that has a melting or decomposition temperature of at least 50° C. and preferably at least 100° C. Examples of useful shell materials include crosslinked thermoset resins such as crosslinked melamine-formaldehyde, crosslinked melamine, crosslinked resorcinol urea formaldehyde and gelatin.

The encapsulated phase change material is in the form of particles. The particles may have particle sizes of 100 nm to 100 μm as measured by microscopy. In some embodiments, the particles have particle sizes of at least 250 nm, at least 500 nm, at least 1 μm or at least 5 μm, and up to 75 μm or up to 50 μm.

Suitable methods for preparing the encapsulated phase change material are described, for example, in U.S. Pat. Nos. 10,221,323 and 10,005,059.

Suitable encapsulated phase change materials are available from Microtek Laboratories, Dayton, Ohio, US.

The encapsulated phase change material constitutes 10 to 70 weight percent of the combined weight of the elastomeric polymer, encapsulated phase change material and ceramic particles. In some embodiments the encapsulated phase change material constitutes at least 25 weight percent, at least 40 weight percent or at least 50 weight percent on the foregoing basis, and up to 65 weight percent or up to 60 weight percent, on the same basis.

The ceramic particles are generally characterized as being non-metallic inorganic solids at 23° C. and having a melting or decomposition (if the ceramic particles decompose without melting) temperature of at least 200° C. The ceramic material is a compound of at least two chemical elements, of which at least one is a non-metal. The ceramic particles may be amorphous, semi-crystalline or crystalline, but do not undergo a phase change in the temperature range of 0 to 50° C. The ceramic material preferably has a thermal conductivity of at least 50 W/(mK) in at least one direction, as measured according to ASTM C1470. Examples of useful ceramic particles include boron nitride, which may be amorphous or in the hexagonal, cubic and/or wurtzite form, and silicon nitride.

The ceramic particles have a particle size of up to 50 μm. Particle sizes herein refer to the longest dimension of primary (non-agglomerated) particles, as determined using microscopic methods. A preferred minimum particle size is at least 100 nm, at least 250 nm or at least 500 nm. A preferred maximum particle size is up to 20 μm, up to 10 μm or up to 5 μm.

The ceramic particles constitute 2 to 25 weight percent of the combined weight of the elastomeric polymer, encapsulated phase change material particles and ceramic particles. In some embodiments the ceramic particles constitute at least 5 weight percent or at least 8 weight percent on the same basis, and constitute up to 20 weight percent or up to 15 weight percent, again on the same basis.

The coating in some embodiments is produced by forming an emulsion and/or dispersion of the elastomeric polymer, encapsulated phase change material and ceramic particles, applying the emulsion or dispersion to a surface of the polyurethane foam and curing the emulsion to produce the cured coating. “Cured” is used in this context to simply mean that the coating composition is formed into a solid coating by any mechanism or combination of mechanisms as appropriate for the particular elastomeric polymer that is present. It is not necessary that any chemical reaction (such as, for example, polymerization, crosslinking or chain extension) take place during the curing step, although such a reaction may take place in some cases. Curing may simply involve drying the applied emulsion or dispersion to produce a solid coating.

A coating composition in the form of an emulsion or dispersion includes a continuous liquid phase. The continuous liquid phase contains water and/or one or more other compounds that are liquid at room temperature (23° C.) and having a boiling temperature at standard pressure of 40 to 100° C.; such materials may constitute, for example, 10 to 50% of the total weight of the coating composition. The elastomeric polymer is dispersed in the continuous liquid phase in the form of particles or droplets. The particles of the encapsulated phase change material and the ceramic particles also are dispersed therein. The emulsion preferably is aqueous, i.e., the continuous liquid phase includes water. Preferably the emulsion or dispersion contains no more than 10% by weight, especially no more than 5% or no more than 2%, of room temperature liquid organic compounds that have a boiling temperature at standard pressure of 40 to 100° C., based on the combined weight of such organic compounds and water.

The elastomeric polymer may be present in an emulsion that is produced in a emulsion polymerization process in which one or more monomers are dissolved or dispersed into a liquid phase and subjected to polymerization conditions until polymer chains precipitate and are converted to solid polymer particles dispersed in a liquid phase. The liquid phase in such an emulsion polymerization process can form some or all of the liquid phase of the emulsion or dispersion used to coat the polyurethane foam in accordance with this invention.

Similarly, an emulsion or dispersion of the elastomeric polymer can be produced in a mechanical dispersion process in which molten elastomeric polymer is dispersed into a liquid phase. The liquid phase in such a mechanical dispersion process can form some or all of the liquid phase of the emulsion or dispersion used to coat the polyurethane foam in accordance with this invention.

In yet another suitable process, the elastomeric polymer may be ground or otherwise formed into small particles that are then dispersed in a liquid phase.

A coating composition in the preferred form of an emulsion and/or dispersion is conveniently formed by combining an emulsion or dispersion of the elastomeric polymer with the phase change particles and the ceramic particles, at proportions as indicated before.

Such a coating composition may include one or more optional materials, in addition to those already described.

Among the useful optional materials is one or more hydrophilic polymers that are liquid at room temperature (23° C.) and have a weight average molecular weight of 350 to 8,000, especially 350 to 1200 or 350 to 800 g/mol as measured by gel permeation chromatography. The hydrophilic polymer preferably is water-soluble. Such a hydrophilic polymer may contain at least 50 weight-% or at least 75 weight-% oxyethylene units, and may be, for example a homopolymer of ethylene oxide or a copolymer (random and/or block) of ethylene oxide and one or other alkylene oxides such as 1,2-propylene oxide. Such a hydrophilic polymer, when present, may constitute 0.1 to 15 percent of the combined weight of the hydrophilic polymer, elastomeric polymer, encapsulated phase change material and ceramic particles. A preferred amount is at least 1, at least 2, at least 4 or at least 5 weight-percent and up to 12, up to 10 or up to 8 weight percent, on the same basis.

Another useful optional material is one or more surfactants, which can perform one or more useful functions. Such a surfactant may function as a wetting agent, facilitating the dispersion of the particles of the phase change material and/or the ceramic particles into the remaining ingredients of the coating composition. A surfactant may function as a defoamer or deaerator, to reduce the entrainment of gases by the coating composition and reduce bubbles. Various silicone surfactants are useful for these purposes, as well as various non-silicone surfactants such as sulfate esters, sulfonate esters, phosphate esters, ethoxylates, fatty acid esters, amine oxides, sulfoxides and phosphine oxides. A surfactant may be nonionic, anionic, cationic or zwitterionic. One or more surfactants may constitute, for example, 0.1 to 5 weight-percent based on the total weight of the coating composition.

Other useful ingredients include various rheology modifiers such as various thickeners and thixotropic agents. Among these are fumed silica and various water-soluble or water-swellable polymers of acrylic acid that contain free acid groups or carboxylic acid salt groups (such as, for example, alkali metal, ammonium (NH₄), quaternary ammonium, or quaternary phosphonium carboxylic acid salts). Particularly useful rheology modifiers include aqueous emulsions of crosslinked acrylic acid polymers, such as are sold by DuPont under the trade designation Acrysol®. Specific examples are Acrysol® ASE-60 and Acrysol ASE-95. When present, such rheology modifiers may constitute, for example, 0.01 to 5 weight-percent, preferably 0.05 to 1 weight percent, of the coating composition.

Still other useful ingredients include one or more colorants, preservatives, antioxidants and biocides.

The coating composition is conveniently prepared by mixing the foregoing ingredients. When the elastomeric polymer is provided in the form of an emulsion or dispersion, it is convenient to mix the remaining ingredients into the emulsion or dispersion of the elastomeric polymer in any convenient order with mixing to produce a homogeneous dispersion.

A useful way of producing a coating composition of the invention is to charge a portion of the liquid phase to a vessel. The hydrophilic polymer, if used, is mixed with this portion of the liquid phase, in the absence of the elastomeric polymer. The ceramic particles are then combined with the portion of the liquid phase (and hydrophilic polymer, if used) in the vessel, followed by adding the elastomeric polymer, preferably in the form of an emulsion or dispersion, the encapsulated phase change material, and other ingredients in any convenient order.

In a particular embodiment, the coating composition is prepared using an apparatus as shown schematically in FIG. 1. Apparatus 1 includes mixing vessel 2, which has a curved bottom section and straight (vertical) sides. The curved bottom section and straight sides meet at tangent line 17. The straight sides define an internal diameter Y. Mixing vessel 2 in some embodiments lacks internal baffles. Apparatus 1 as shown includes an agitation system that includes motor 7, shaft 5, disperser impeller 4 and impeller 6. Shaft 4 preferably is oriented vertically within mixing vessel 2 along a central vertical axis. Disperser impeller 4 and impeller 6 preferably are oriented horizontally.

Disperser impeller 4 may be, for example, a Cowles blade impeller or a Conn blade impeller. Disperser impeller 4 preferably has an overall length D that is in the range of 0.35 to 0.7 Y, especially 0.45 to 0.55 Y. Disperser impeller 4 preferably is at the same height as tangent line 17 or no more than 10 cm or no more than 5 cm above or below tangent line 17.

Impeller 6 is a pumping impeller such as a type A320 impeller from Chemineer or a Pitch Blade Turbine (PBT) impeller. Impeller 6 is located on shaft 5 above disperser impeller 4, preferably by a distance of 0.5D to 0.75 D during operation. Impeller 6 may be variably positionable along the vertical length of shaft 5 so its vertical position relative to disperser impeller 4 can be adjusted. Impeller 6 preferably has an overall length that is in the range of 0.35 to 0.7 Y, especially 0.45 to 0.55 Y.

In an alternative design, impeller 6 is positioned below disperser impeller 4, preferably by a distance of 0.5D to 1 D, especially 0.65 to 0.85D, and a second impeller 6 is positioned on shaft 5 above disperser impeller 4, again preferably by a distance of 0.5D to 1 D, especially 0.65 to 0.85D

Apparatus 1 further includes powder vessel 8 for holding ceramic particles and powder dispenser 9 for dispensing the ceramic particles from powder vessel 8 into vessel 2. Powder dispenser 2 preferably permits a variable and controllable rate of dispensing the powder.

Apparatus 1 as shown further includes optional recirculation loop 10 which as shown includes conduits 14, valve 11, pump 12 and rotostator 13. Recirculation loop 10 removes material from the bottom of mixing vessel 10 and transports the removed material back to the top of mixing vessel 10, where it is re-introduced into mixing vessel 10. Rotor stator 13 provides additional mixing if desired.

In a preferred mixing process, all or a portion of the liquid phase is charged into the interior of mixing vessel 2. This preferably includes at least some water and the hydrophilic polymer if used. Impeller 6 is positioned above the fluid level during a first step of mixing. Disperser impeller 4 is positioned beneath the surface of the fluid in mixing vessel 2. Disperser impeller 4 is rotated to agitate the fluid and create vortex 16 on surface 15 of the fluid in reaction vessel 2. The Froude number of disperser impeller 4 in this step may be, for example, 0.12 to 0.5, to create the desired vortex. The ceramic particles then are added to reaction vessel 2 continuously or intermittently from power vessel 8 via powder dispenser 9 while continuing agitation, maintaining the fluid level below impeller 6 so impeller 6 is not involved in the mixing. Powder dispenser 9 preferably dispenses the ceramic particles close to the eye of the vortex, such that the ceramic particles do not fall on the shaft. The resulting mixture of fluid and ceramic particles may be agitated for a period after all of the ceramic particles have been added.

Impeller 6 is then positioned below surface 15 of the contents of mixing vessel 2. The elastomeric polymer is then added, preferably in the form of an emulsion or dispersion in more of the fluid phase, and the phase change material is then added. Optional ingredients are added before, during or after the addition of the elastomeric polymer and the phase change material. Agitation is maintained during this step to maintain vortex 16. Agitation may be continued for a period after all ingredients have been added. If desired, a recirculation of material may be established during this step through recirculation loop 10. The shear rate inside rotor-stator 13 preferably is maintained at less than 1000 sec⁻¹ to avoid breaking the encapsulation of the PCM microspheres. The completed coating composition is then discharged for packaging, storage, transportation and/or usage.

The coating composition can be applied to at least one external surface of a polyurethane foam. The coating method is not particularly critical. Rolling, brushing, spraying, immersion or other coating methods are suitable.

Enough of the coating composition preferably is applied that, after curing, a cured coating having a thickness of 100 μm to 10 mm is produced. The coating thickness is preferably at least 250 μm or at least 350 μm and up to 2,500 μm, up to 1500 μm or up to 1000 μm.

The coating composition is cured on the surface of the polyurethane foam. The curing method may depend somewhat on the particular elastomeric polymer and/or on the physical form of the coating composition. The curing of a coating composition in the form of an emulsion includes at least a drying step of removing water and/or one or more other compounds that are liquid at room temperature (23° C.) and having a boiling temperature at standard pressure of 40 to 100° C., as may be present in the coating composition. Such a drying step can be performed at approximately room temperature, such as from 15 to 30° C., or at an elevated temperature such as greater than 30° C. up to 100° C. or more.

If curing includes a chemical reaction (such as, for example, polymerization, crosslinking or chain extension), conditions of the curing reaction, such as temperature, the presence of coreactants, catalysts, initiators, etc. not otherwise present in the coating composition, etc., are selected to facilitate the chemical reaction to complete the cure.

The coated foam in some embodiments exhibits a microtexture roughness value of at most 50, preferably 20 to 45; a microtexture coarseness value of at most 20, preferably 8 to 18; an adhesive tack value of at most 15, preferably 5 to 10; a thermal cooling value of at least 8, preferably 9 to 15; and a thermal persistence value of at least 8, preferably 10 to 15, all as measured using the BioTac® Toccare apparatus as described in the following examples. The coated foam in some embodiments exhibits a durometer harness of at most 15 on the 00 scale as measured according to ASTM D2240.

The following examples are provided to illustrate the invention, but are not intended to limit the scope thereof. All parts and percentages are by weight unless otherwise indicated.

The Deaerator is a polyether siloxane copolymer with fumed silica, sold as Tego Airex 904W by Evonik.

The Emulsion is an acrylic latex polymer emulsion with 55% solids by weight. The latex particles are an elastomeric polymer having a T_{g} of −50° C. The Emulsion is available as Rhoplex 3166 from The Dow Chemical Company.

PEG is a polyethylene glycol having an average nominal hydroxyl functionality of 2 and a number average molecular weight of approximately 600 g/mole.

The Silicone Surfactant is available from The Dow Chemical Company under the trade name DC-52.

RM (rheology modifier) 1 is an aqueous emulsion containing cross-linked acrylate polymer particles having acid groups. The solids content is 28%. When diluted with water and neutralized with a base (NH₄OH), this product acts as a thickener.

RM 2 is an aqueous emulsion containing cross-linked acrylate polymer particles having acid groups. The solids content is 18%. When diluted with water and neutralized with a base (NH₄OH), this product acts as a thickener.

NH₄OH is a 28-30% ammonium hydroxide solution, for neutralizing RM 1 and/or RM 2.

BN is boron nitride (at least 98% pure), in the form of platelets having a longest dimension of about 1 to 3 μm, available from Wego Chemical.

PCM 1 is a microencapsulated paraffin wax having a particle size of 15 to 30 μm. The wax constitutes 85-90% of the weight of the material, a polymeric shell constituting the remainder of the weight of the product. The phase change material has a melting of approximately 28° C. The product has an enthalpy of melting of 180-190 J/g. It is commercially available as MPCM 28D from Microtek Laboratories.

PCM 2 is a microencapsulated paraffin wax having a particle size of 15 to 30 μm. The wax constitutes 85−90% of the weight of the material, a polymeric shell constituting the remainder of the weight of the product. The phase change material has a melting of approximately 32° C. The product has an enthalpy of melting of 160-170 J/g. It is commercially available as MPCM 32D from Microtek Laboratories.

PCM 3 is a microencapsulated paraffin wax having a particle size of 14-24 μm. The wax constitutes 85-90% of the weight of the material, a polymeric shell constituting the remainder of the weight of the product. The phase change material has a melting of approximately 28° C. The product has an enthalpy of melting of 180-190 J/g. It is commercially available as Nextek 28D from Microtek Laboratories.

PCM 4 is a microencapsulated paraffin wax having a particle size of 15-30 μm. The wax constitutes 85-90% of the weight of the material, a polymeric shell constituting the remainder of the weight of the product. The phase change material has a melting of approximately 32° C. The product has an enthalpy of melting of about 170 J/g. It is commercially available as Nextek 32D from Microtek Laboratories.

Coating compositions are made from the ingredients listed in Table 1 by combining them and mixing them in a high-speed laboratory mixer to produce a homogeneous mixture.

TABLE 1

| | Parts By Weight | | | | | | | |
|---|---|---|---|---|---|---|---|---|
| | Comp. | | | | | Comp. | Comp. | Comp. |
| Ingredient | A* | Ex. 1 | Ex. 2 | Ex. 3 | Ex. 4 | B* | C* | D |
| Water | 10 | 10 | 10 | 10 | 10 | 10 | 10 | 10 |
| PEG | 4 | 4 | 4 | 0 | 4 | 4 | 4 | 4 |
| Silicone | 2 | 2 | 0 | 2 | 2 | 2 | 2 | 2 |
| Surfactant | | | | | | | | |
| Emulsion | 44 | 40 | 42 | 44 | 40 | 40 | 40 | 40 |
| Deaerator | 0.1 | 0.1 | 0.1 | 0.1 | 0.1 | 0.1 | 0.1 | 0.1 |
| RM 1 | 0.2 | 0.2 | 0.2 | 0.2 | 0.2 | 0.2 | 0.2 | 0.2 |
| RM 2 | 0.2 | 0.2 | 0.2 | 0.2 | 0.2 | 0.2 | 0.2 | 0.2 |
| NH₄OH | 0.6 | 0.6 | 0.6 | 0.6 | 0.6 | 0.6 | 0.6 | 0.6 |
| PCM 1 | 0 | 0 | 0 | 0 | 35 | 0 | 0 | 0 |
| PCM 2 | 0 | 0 | 0 | 0 | 1.5 | 0 | 0 | 0 |
| PCM 3 | 34.4 | 34.4 | 35 | 34.4 | 0 | 34.4 | 34.4 | 34.4 |
| PCM 4 | 1.5 | 1.5 | 1.5 | 1.5 | 0 | 1.5 | 1.5 | 1.5 |
| BN | 0 | 7 | 7 | 7 | 7 | 0 | 0 | 0 |
| Aluminum | 0 | 0 | 0 | 0 | 0 | 7 | 0 | 0 |
| Copper | 0 | 0 | 0 | 0 | 0 | 0 | 7 | 0 |
| Graphite | 0 | 0 | 0 | 0 | 0 | 0 | 0 | 7 |
| Approximate | 0 | 11 | 10.5 | 10.5 | 10.5 | 10.5 | 10.5 | 10.5 |
| filler content, | | | | | | | | |
| wt-%¹ | | | | | | | | |
| Approximate | 60 | 55 | 55 | 53.5 | 56 | 56 | 56 | 56 |
| encapsulated | | | | | | | | |
| PCM content, | | | | | | | | |
| wt-%¹ | | | | | | | | |

*Not an example of the invention.
¹Based on the combined weight of the elastomeric polymer, the PCM and filler material. The fillers are BN, Al, Cu or graphite, as indicated.

The coating compositions are used to produce coatings on viscoelastic polyurethane foams. A weighed amount of the coating composition is poured onto a top surface of a foam sample and spread using a roller brush to produce a smooth layer of uniform thickness with a surface area of about 316 cm². The applied coating is cured by heating the coated foam at 80° C. for 20 minutes, to produce a coating having a thickness of about 500 μm.

The coating compositions are formulated in each case such that the cured coating, in the absence of the phase change material and filler, has a T_{g} of less than −15° C.

Microtexture roughness, microtexture coarseness, adhesive tack, thermal cooling and thermal persistence of the coated surface are evaluated using a BioTac® Toccare device (Suntouch, Montrose, Calif.), which reports values for each attribute on a relative scale. For the intended bedding applications, lower values for microtexture roughness, microtexture coarseness and adhesive tack are preferred, and higher values are preferred for thermal cooling and thermal persistence. In addition, the coating hardness (durometer 00 scale) is measured using a durometer according to ASTM D2240. Results are as indicated in Table 2.

TABLE 2

| | Result | | | | | | | |
|---|---|---|---|---|---|---|---|---|
| | Comp. | | | | | Comp. | Comp. | Comp. |
| Test | A* | Ex. 1 | Ex. 2 | Ex. 3 | Ex. 4 | B* | C* | D |
| Filler | None | BN | BN | BN | BN | Al | Cu | Graphite |
| Microtexture | 36.25 | 24.94 | 43.47 | 49.88 | 17.61 | 46.09 | 47.22 | 42.79 |
| roughness¹ | | | | | | | | |
| Microtexture | 13.13 | 11.31 | 17.51 | 29.29 | 8.68 | 22.57 | 17.61 | 16.24 |
| coarseness¹ | | | | | | | | |
| Adhesive tack¹ | 32.43 | 8.55 | 9.67 | 5.53 | 9.67 | 7.44 | 7.44 | 7.71 |
| Thermal | 9.58 | 10.07 | 12.02 | 10.28 | 12.60 | 6.59 | 10.03 | 10.16 |
| Cooling¹ | | | | | | | | |
| Thermal | 10 | 10.81 | 13.98 | 11.37 | 13.48 | 6.52 | 10.64 | 10.74 |
| Persistance¹ | | | | | | | | |
| Durometer 00 | ~5 | ~5 | ~13 | ~16 | ~6 | ND | ND | ND |
| Hardness | | | | | | | | |

*Not an example of the invention.
¹Ratings on a relative scale produced by the test device.
ND = not determined.

Comparative Sample A, which contains no boron nitride or other ceramic, exhibits good microtexture properties, but is relatively tacky. It has acceptable thermal properties. Example 1 demonstrates the effect of incorporating boron nitride particles into the coating composition of Comparative Sample A. Microtexture properties improve and adhesive tack is reduced dramatically. Thermal cooling and persistence each improve by 5-8%.

Examples 2 and 3 show the effect of removing the PEG and surfactant, respectively, from the coating composition of Example 1. Adhesive tack remains low, and the thermal properties are further improved. Some loss of microtexture performance is seen, however, suggesting that including the PEG and surfactant is preferable.

Example 4 is a repeat of Example 1, except a different phase change material is used. This sample has excellent properties in all respects. Microtexture roughness and coarseness are very low, as is adhesive tack, and thermal properties are substantially improved compared with Example 1 and Comparative Sample A.

Comparative Samples B, C and D show the effect of substituting alternative thermally-conductive materials for boron nitride. Aluminum (Comp. B) yields very poor thermal properties. Copper (Comp. C) and graphite (Comp. D) each yields good tack and thermal properties but their microtexture properties are far worse than Examples 1 and 2 (which, like Comp. C and Comp. D, includes the PEG and silicone surfactant). In addition, Comparative Samples B, C and D are all highly colored due to the incorporation of the metallic or graphite filler particles. Comparative Sample D in particular is black and is not amenable to being colored through the use of other dyes or pigments.

1. An article comprising a flexible polyurethane foam and a cured coating of a solid, water-insoluble elastomeric polymer adhered to at least one surface of the flexible polyurethane foam, the cured coating having embedded therein (i) particles of an encapsulated phase change material, the phase change material having a melting or glass transition temperature of 25 to 37° C. and (ii) ceramic particles having a particle size of up to 50 μm, the encapsulated phase change material constituting 10 to 70 weight percent of the combined weight of the cured coating, encapsulated phase change material particles and ceramic particles, and the ceramic particles constituting 2 to 25 weight percent of the combined weight of the elastomeric polymer, encapsulated phase change material particles and ceramic particles.

2. The article of claim 1 wherein the cured coating has a thickness of 100 to 2500 μm.

3. The article of claim wherein the phase change material comprises any one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax.

4. The article of claim 3 wherein the flexible polyurethane foam prior to coating has a density of 32 to 92 kg/m³, and exhibits a recovery time of 1 to 10 seconds and a resiliency of less than 20%.

5. The article of claim 3 wherein the ceramic particles are boron nitride or silicon nitride particles having a particle size of 100 to 3000 μm.

6. The article of claim 3 wherein the phase change material constitutes 40 to 60 percent of the total weight of the elastomeric polymer, encapsulated phase change material particles and ceramic particles.

7. The article of claim 3 wherein the ceramic particles constitute 8 to 20 percent of the total weight of the elastomeric polymer, encapsulated phase change material particles and ceramic particles.

8. The article of claim 3 wherein the cured coating further contains a hydrophilic polymer that is a liquid at 23° C. and has a weight average molecular weight of 350 to 8000 g/mol, wherein the hydrophilic polymer constitutes 0.1 to 15 percent of the total weight of the elastomeric polymer, encapsulated phase change material particles, ceramic particles and hydrophilic polymer.

9. A coating composition comprising a liquid phase containing water and/or one or more other compounds that are liquid at 23° C. and have a boiling temperature at standard pressure of 40 to 100° C., a water-insoluble elastomeric polymer dispersed in the liquid phase in the form of particles or droplets, particles of an encapsulated phase change material dispersed in the liquid phase and ceramic particles dispersed in the liquid phase, wherein the phase change material constitutes 40 to 60 percent of the total weight of the elastomeric polymer, encapsulated phase change material particles and ceramic particles and the ceramic particles constitute 8 to 20 percent of the total weight of the elastomeric polymer, encapsulated phase change material particles and ceramic particles.

10. The coating composition of claim 9 wherein the phase change material comprises any one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax, and the ceramic particles are boron nitride or silicon nitride particles having a particle size of 100 to 3000 μm.

11. The coating composition of claim 10 further comprising a hydrophilic polymer that is a liquid at 23° C. and has a weight average molecular weight of 350 to 8000 g/mol, wherein the hydrophilic polymer constitutes 0.1 to 15 percent of the total weight of the elastomeric polymer, encapsulated phase change material particles, ceramic particles and hydrophilic polymer.

12. A method for preparing a coating composition of claim 9, comprising:
A. charging all or a portion of the liquid phase into the interior of a mixing vessel equipped with an agitation system that includes a motor, shaft, disperser impeller and at least one pumping impeller the disperser impeller and pumping impeller being mounted on the shaft with the pumping impeller being positioned above the disperser impeller;
B. rotating a disperser impeller to agitate the liquid phase in the mixing vessel to create a vortex at a surface of the liquid phase in the mixing vessel, while maintaining the pumping impeller above the surface of the liquid phase in the mixing vessel;
C. adding the ceramic particles to the liquid phase while continuing to rotate the disperser impeller while maintaining the surface of the liquid phase in the mixing vessel below the pumping impeller;
D. then positioning the pumping impeller below the surface of the liquid phase in the mixing vessel and adding the elastomeric polymer and optionally additional liquid phase to the liquid phase in the mixing vessel while agitating the liquid phase with both the disperser impeller and the pumping impeller to maintain a vortex at the surface of the liquid phase;
E. simultaneously with or after step D, adding the encapsulated phase change material to the liquid phase in the mixing vessel while continuing agitation with both the disperser impeller and the pumping impeller to maintain a vortex at the surface of the liquid phase.
